(19) United States
(12) Patent Application Publication
(10) Pub. No.: US 2012/0208084 A1
(43) Pub. Date: Aug. 16, 2012

(54) NEGATIVE ELECTRODE FOR LITHIUM ION SECONDARY BATTERIES, AND LITHIUM ION SECONDARY BATTERY

(76) Inventors: Tatsuki Hiraoka, Osaka (JP); Taisuke Yamamoto, Nara (JP); Katsumi Kashiwagi, Nara (JP); Masaya Ugaji, Osaka (JP)

(21) Appl. No.: 13/502,068

(22) PCT Filed: Apr. 26, 2011
(86) PCT No.: PCT/JP2011/002451

§ 371 Date: Apr. 13, 2012

(30) Foreign Application Priority Data
Jun. 29, 2010 (JP) 2010-148154

(51) Int. Cl. H01M 4/70; H01M 4/66; H01M 4/64

(52) U.S. Cl. 429/211

(57) ABSTRACT

A negative electrode for lithium ion secondary batteries, including: a negative electrode current collector having a plurality of protrusions formed on a surface thereof; and a plurality of granular bodies, the granular bodies being supported on the protrusions, respectively, and including an alloy-formable active material capable of absorbing and releasing lithium ions, wherein: the granular bodies have a resin layer on their respective surfaces; and the resin layer includes a first resin component which is at least one selected from polyimides and polyacrylic acid, and a second resin component which is composed of a copolymer including vinylidene fluoride units and hexafluoropropylene units. A lithium ion secondary battery including the above negative electrode.

### TECHNICAL FIELD

The present invention relates to a negative electrode for lithium ion secondary batteries, and a lithium ion secondary battery. More specifically, the present invention relates to improvement of a negative electrode, in a lithium ion secondary battery which uses an alloy-formable active material as a negative electrode active material.

### BACKGROUND ART

A lithium ion secondary battery which uses an alloy-formable active material as the negative electrode active material (hereinafter referred to as “alloy-based secondary battery”), has higher capacity and energy density than a conventional lithium ion secondary battery which uses graphite as the negative electrode active material. Therefore, there is high expectation for alloy-based secondary batteries, not only as the power source for electronic equipment, but also as the main power sources or auxiliary power sources for transport equipment, machine tools, etc. Known as alloy-formable active materials, are: silicon-based active materials such as silicon, silicon oxides, and silicon alloys; and tin-based active materials such as tin and tin oxides.

PTL 1 discloses a negative electrode for lithium ion secondary batteries, in which silicon particles and/or silicon alloy particles are bonded to the negative electrode current collector surface, with use of a polyimide or an imide compound. PTL 2 discloses a negative electrode for non-aqueous electrolyte secondary batteries, in which silicon-based active material particles are bonded to the negative electrode current collector surface, with use of a polyimide and polyacrylic acid.

If the negative electrodes disclosed in PTL 1 and PTL 2 are used, cycle characteristics would degrade due to separation of the negative electrode active material layer from the negative electrode current collector, deformation of the negative electrode, or the like, caused by internal stress generated when the silicon-based active material particles expand significantly during charge.

PTL 3 discloses a negative electrode, in which a plurality of micron-sized columnar bodies comprising an alloy-formable active material is supported on a plurality of protrusions formed on the negative electrode current collector surface, and a gap is created between the columnar bodies adjacent to each other. The above gap enables reduction in internal stress generated when the columnar bodies comprising an alloy-formable active material, expand. As a result, there is suppression of the columnar bodies separating from the negative electrode current collector, of the negative electrode deforming, etc.

### CITATION LIST

### Patent Literatures

[PTL 1] Japanese Laid-Open Patent Publication No. 2007-242405
[PTL 2] Japanese Laid-Open Patent Publication No. 2007-95670
[PTL 3] WO Publication No. 2008/026595

### SUMMARY OF INVENTION

### Technical Problem

If the negative electrode disclosed in PTL 3 is used, an alloy-based secondary battery, of which cycle characteristics are remarkably superior compared to a conventional alloy-based secondary battery, would be obtained. However, even with an alloy-based secondary battery comprising the negative electrode disclosed in PTL 3, there are instances where cycle characteristics deteriorate as the number of times of charge and discharge increases. The present inventors conducted extensive studies on what causes the above, and as a result, obtained the following findings.

In the negative electrode disclosed in PTL 3, the columnar bodies repeatedly absorb and release lithium ions in a stable manner for a long period of time. However, it has been found that upon expansion and contraction of the columnar bodies, highly microscopic gaps are created inside the columnar bodies. Newly generated inside the columnar bodies due to the above, are faces (hereinafter referred to as “newly-generated face”) being without any direct contact with a non-aqueous electrolyte at that point. The newly-generated faces immediately after their generation are highly reactive.

Additionally, when the newly-generated faces, immediately after their generation, come into contact with the non-aqueous electrolyte, a side reaction other than charge/discharge reactions occurs at the newly-generated faces, thereby producing a by-product. The by-product causes the columnar bodies to deteriorate by forming, on the surfaces of the columnar bodies, a film which prevents charge/discharge reactions from occurring. With advanced deterioration of the columnar bodies, it becomes easier for the columnar bodies to separate from the protrusion surfaces. Also, the amount of the non-aqueous electrolyte inside the battery becomes deficient by the non-aqueous electrolyte being consumed due to the side reaction at the newly-generated faces. As a result of above, cycle characteristics deteriorate rapidly.

An object of the present invention is to provide a lithium ion secondary battery comprising a negative electrode which includes an alloy-formable active material serving as a negative electrode active material, and also having excellent cycle characteristics.

### Solution to Problem

One aspect of the present invention relates to a negative electrode for lithium ion secondary batteries, comprising: a negative electrode current collector having a plurality of protrusions formed on a surface thereof; and a plurality of granular bodies, the granular bodies being supported on the protrusions, respectively, and including an alloy-formable active material capable of absorbing and releasing lithium ions, wherein the granular bodies each have a resin layer including: a first resin component which is at least one selected from polyimides and polyacrylic acid; and a second resin component which is composed of a copolymer including vinylidene fluoride units and hexafluoropropylene units.

Another aspect of the present invention relates to a lithium ion secondary battery comprising: a positive electrode capable of absorbing and releasing lithium ions; the above negative electrode; a separator interposed between the positive electrode and the negative electrode; and a non-aqueous electrolyte.

### Advantageous Effect of Invention

According to the present invention, a lithium ion secondary battery having high capacity, high energy density, and excellent cycle characteristics, is provided.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a vertical sectional view schematically showing the structure of a lithium ion secondary battery according to one embodiment of the present invention.

FIG. 2 is a vertical sectional view schematically showing the structure of a negative electrode included in the lithium ion secondary battery shown in FIG. 1.

FIG. 3 is a vertical sectional view schematically showing the structure of a granular body included in the negative electrode shown in FIG. 2.

FIG. 4 is a front view schematically showing the inside configuration of an electron-beam vacuum deposition device.

FIG. 5 is a front view schematically showing the inside configuration of another kind of a vacuum deposition device.

### DESCRIPTION OF EMBODIMENTS

A negative electrode for lithium ion secondary batteries, of the present invention, comprises: a negative electrode current collector having a plurality of protrusions formed on a surface thereof; and a plurality of granular bodies, the granular bodies being supported on the protrusions, respectively, and including an alloy-formable active material capable of absorbing and releasing lithium ions. Also, the granular bodies each have a resin layer on their respective surfaces. The resin layer includes: a first resin component which is at least one selected from polyimides and polyacrylic acid; and a second resin component which is composed of a copolymer including vinylidene fluoride units and hexafluoropropylene units.

As such, covering the surface of the granular body (e.g., columnar body) with the resin layer causes suppression of contact between the newly-generated faces immediately after their generation inside the granular body, and a non-aqueous electrolyte. As a result, there is suppression of a side reaction which is due to contact between the newly-generated faces and a non-aqueous electrolyte, as well as of deterioration of the granular bodies. Also, there is lesser separation of the granular bodies from the protrusions, and lesser excessive non-aqueous electrolyte consumption. Thus, there is further improvement in cycle characteristics of lithium ion secondary batteries.

Additionally, since the resin layer includes the first resin component and the second resin component, even if the granular body expands and contracts repeatedly, durability of the resin layer, ability of the resin layer to follow the granular body expanding and contracting (hereinafter, simply referred to as “followability”), and adhesion between the granular body surface and the resin layer (hereinafter, simply referred to as “adhesion”), would all be maintained. In addition to the above, the resin layer has a moderate level of lithium ion conductivity. This enables suppression of deterioration in load characteristics and in output characteristics of lithium ion secondary batteries, and enables further improvement in cycle characteristics thereof.

The surface of the granular body is preferably covered with the resin layer without unevenness. As a result, the effect of the resin layer spreads through most of the negative electrode, thereby suppressing local deterioration in the negative electrode more effectively.

The thickness of the resin layer is preferably 0.1 μm to 5 μm. This enables a balanced retention between: followability and adhesion of the resin layer to the granular body surface; and lithium ion conductivity thereof.

It is preferable that the content of the first resin component is 50 mass % to 99 mass % and the content of the second resin component is 1 mass % to 50 mass %, in the resin layer. It is further preferred that the ratio of the first resin component content:the second resin component content is 1:0.2 to 1:1, by mass. By having the first resin component and the second resin component included in the resin layer at a specific ratio as above, the resin layer would function more sufficiently, even if there are expansion and contraction of the granular body, contact of the resin layer with a non-aqueous electrolyte, etc.

It is preferable that the degree of swelling of a copolymer serving as the second resin component is 15% or more in a non-aqueous electrolyte. This enables retention of lithium ion conductivity of the resin layer to be within a moderate range, thereby further suppressing deterioration in load characteristics, etc. of the battery.

It is preferable that the coverage of the resin layer on the granular body surface (hereinafter, simply referred to as “coverage of the resin layer”), is 30% to 100%. Also, it is preferable that the coverage of the resin layer at full charge, is 50% to 100%. This enables a more sufficient realization of the effect of the resin layer in suppressing contact between the newly-generated faces immediately after their generation, and a non-aqueous electrolyte.

It is preferable that the alloy-formable active material is at least one selected from silicon-based active materials and tin-based active materials. The alloy-formable active material as above not only has high capacity, but also is excellent in handleability.

A lithium ion secondary battery of the present invention comprises: a positive electrode capable of absorbing and releasing lithium ions; the above negative electrode capable of absorbing and releasing lithium ions; a separator interposed between the positive and negative electrodes; and a non-aqueous electrolyte. The lithium ion secondary battery as above has high capacity due to its use of an alloy-formable active material, and has excellent cycle characteristics whether it is configured to be of a low-output type or of a high-output type.

In the lithium ion secondary battery of the present invention, it is preferable to use the negative electrode having the resin layer which includes as the second resin component, a copolymer of which the degree of swelling in a non-aqueous electrolyte is 15% or more. This enables improvement in cycle characteristics of the lithium ion secondary battery of the present invention, without adversely affecting load characteristics and output characteristics thereof.

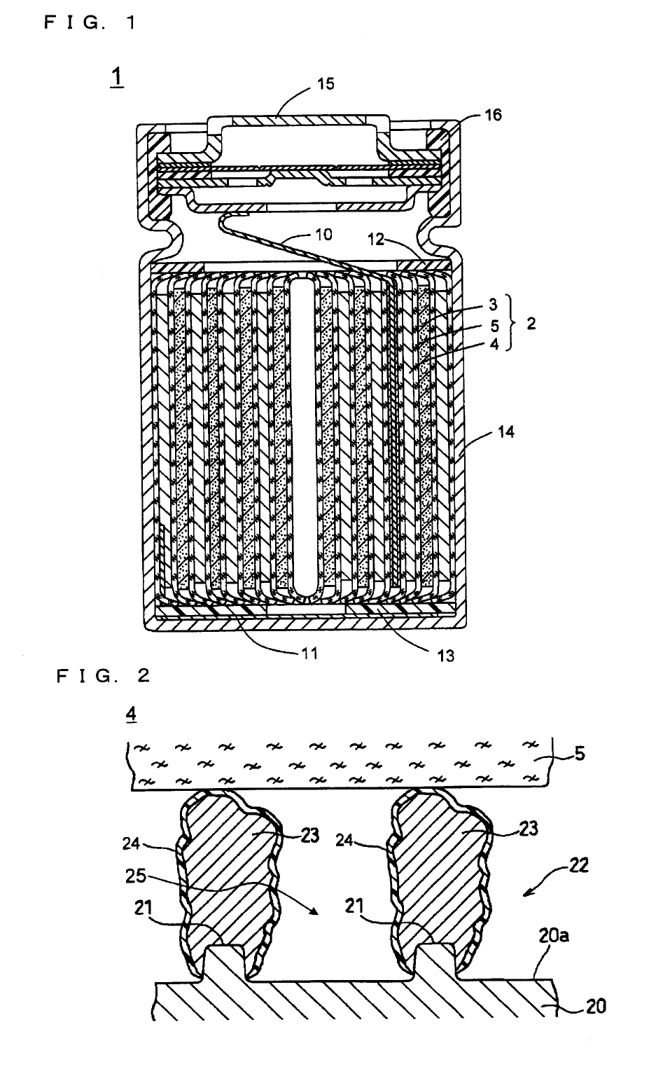

FIG. 1 is a vertical sectional view schematically showing the structure of a lithium ion secondary battery 1 according to one embodiment of the present invention. FIG. 2 is a vertical sectional view schematically showing the structure of a negative electrode 4 included in the lithium ion secondary battery 1 shown in FIG. 1.

The lithium ion secondary battery 1 includes a wound electrode assembly 2 (hereinafter, simply referred to as “electrode assembly 2”) obtained by winding a positive electrode 3 and the negative electrode 4 with a separator 5 interposed therebetween. Attached on the longitudinal ends of the electrode assembly 2, are an upper insulating plate 12 and a lower insulating plate 13, respectively, and the resultant is housed together with a non-aqueous electrolyte (not shown), inside a bottomed and cylindrical battery case 14. One longitudinal end of the battery case 14 has an opening, and the other longitudinal end (bottom surface) thereof serves as a negative terminal. A sealing plate 15 is attached at the opening of the battery case 14, with an insulating gasket 16 therebetween, and serves as a positive terminal. A positive lead 10 conducts electricity between a positive electrode current collector in the positive electrode 3 and the sealing plate 15. A negative lead 11 conducts electricity between a negative electrode current collector 20 in the negative electrode 4 shown in FIG. 2, and the battery case 14.

As shown in FIG. 2, the negative electrode 4 comprises: the negative electrode current collector 20 having a plurality of protrusions 21 on both of surfaces 20a thereof; a negative electrode active material layer 22 formed from a plurality of granular bodies 23, the granular bodies 23 being supported on the surfaces of the protrusions 21, respectively; and a resin layer 24 formed on the respective surfaces of the granular bodies 23. Also, the resin layer 24 includes: a first resin component which is at least one selected from polyimides and polyacrylic acid; and a second resin component which is a copolymer (hereinafter referred to as “VDF-HFP copolymer”) including vinylidene fluoride units and hexafluoropropylene units. The first resin component has relatively greater mechanical strength and elasticity. The second resin component exhibits lithium ion conductivity by contact with the non-aqueous electrolyte.

The resin layer 24 is formed in a manner such that it adheres to the surface of the granular body 23. Therefore, the resin layer 24 covers the surface of the granular body 23. This enables suppression of contact between: the newly-generated faces immediately after their generation inside the granular body 23; and the non-aqueous electrolyte. As a result, there is suppression of a side reaction which is due to the newly-generated faces and the non-aqueous electrolyte. Also, there are significantly lesser separation of the granular bodies 23 from the protrusions 21 and significantly lesser excessive consumption of the non-aqueous electrolyte. Thus, there is improvement in cycle characteristics of the battery 1.

Due to the resin layer 24 including the first resin component which is relatively high in mechanical strength and elasticity, there are improvements in durability of the resin layer 24, in followability of the resin layer 24 to volume changes in the granular body 23, and in adhesion of the resin layer 24 to the granular body 23 surface. This results in adhesion of the resin layer 24 to the granular body 23 surface being stably maintained for a long period of time, and in suppression of the resin layer 24 separating from the granular body 23 surface. This enables the effect of the resin layer 24 being formed on the granular body 23 surface, to be maintained for a long period of time.

Due to the resin layer 24 including the second resin component which exhibits lithium ion conductivity by contact with the non-aqueous electrolyte, it is possible for the granular body 23, via the resin layer 24, to smoothly and stably absorb and release lithium ions. Therefore, by covering the surface of the granular body 23 with the resin layer 24, cycle characteristics of the battery 1 can be further improved without adversely affecting load characteristics, output characteristics, etc. thereof.

The polyimide and the polyacrylic acid which serve as the first resin component both are resin having great mechanical strength and good elasticity. Although there are no particular limitations to the polyimide and the polyacrylic acid, the polyimide preferably has a number average molecular weight of ten thousand to two million, and the polyacrylic acid preferably has a number average molecular weight of ten thousand to four million.

The polyimide and the polyacrylic acid having the number average molecular weights as above, have great mechanical strength and good elasticity in a balanced manner. They are also highly compatible with the second resin component, in an organic solvent. Therefore, by using the polyimide and/or the polyacrylic acid as above, the first and second resin components are well mixed, thereby enabling formation of the resin layer 24 having good durability, followability, and adhesion. Further, lithium ion conductivity of the resin layer 24 can be favorably maintained.

By not making the respective number average molecule weights of the polyimide and the polyacrylic acid too small, there is more effective suppression of deterioration in their mechanical strength and elasticity, and also in durability, followability, etc. of the resin layer 24. Also, by not making the respective number average molecule weights of the polyimide and the polyacrylic acid too large, there is more effective suppression of deterioration in their compatibility with the second resin component in an organic solvent, and it is possible to more effectively prevent the effect of the resin layer 24 from diminishing.

Although there are no particular limitations to the VDF-HFP copolymer which serves as the second resin component, it preferably has a degree of swelling of 15% or more in the non-aqueous electrolyte that is used together with the negative electrode 4 in the battery 1 (hereinafter, referred to simply as “non-aqueous electrolyte”), and preferably is insoluble in the non-aqueous electrolyte. The VDF-HFP copolymer further preferably has a degree of swelling of 15% to 160% in the non-aqueous electrolyte. The VDF-HFP copolymer as above can be obtained by copolymerizing VDF and HFP in a manner such that the content of the HFP units is preferably 0.1 mol % or more and further preferably 2 mol % to 8 mol %.

The VDF-HFP copolymer having the degree of swelling as above exhibits good lithium ion conductivity by contact with the non-aqueous electrolyte, and suppresses deterioration in load characteristics and output characteristics of the battery 1 caused by formation of the resin layer 24. Also, the VDF-HFP copolymer having the degree of swelling as above further improves adhesion as well as followability of the resin layer 24 to the granular body 23 surface, and effectively prevents durability, etc. of the resin layer 24 from being adversely affected.

By not making the degree of swelling of the VDF-HFP copolymer in the non-aqueous electrolyte too low, it is possible to more sufficiently secure lithium ion conductivity of the resin layer 24, and to further suppress deterioration in load characteristics, output characteristics, etc. of the battery 1. By not making the degree of swelling of the VDF-HFP copolymer in the non-aqueous electrolyte too high, the VDF-HFP copolymer is more effectively prevented from dissolving in the non-aqueous electrolyte, and thus, the form of the resin layer 24, the state in which the resin layer 24 adheres to the granular body 23 surface, etc. can be more reliably maintained.

The degree of swelling in the non-aqueous electrolyte is measured as follows. First, a resin is dissolved in an organic solvent to prepare a resin solution; this resin solution is applied to a flat glass surface; and then, the resultant coating is dried, thereby producing a sheet having a thickness of 100 μm. This sheet is cut to a size of 10 mm×10 mm, and the resultant is designated as a sample. Meanwhile, ethylene carbonate and ethyl methyl carbonate are mixed at a volume-to-volume ratio of 1:1, and in the resultant mixed solvent, LiPF₆ is dissolved at a concentration of 1.0 mol/L, thereby preparing a non-aqueous electrolyte. The non-aqueous electrolyte is put into an airtight container, and the sample is immersed in this non-aqueous electrolyte of which the temperature is maintained at 25° C. for 24 hours. Then, by the following formula, the degree of swelling is obtained as the percentage of increase in the mass (H) of the sample after its immersion in the non-aqueous electrolyte, relative to the mass (G) of the sample before its immersion in the non-aqueous electrolyte.

Degree of swelling (%)={(H−G)/G}×100

Note that the VDF-HFP copolymer having a degree of swelling of 15% or more in the non-aqueous electrolyte having the above composition, is considered to similarly exhibit a degree of swelling of 15% or more, also in non-aqueous electrolytes of various compositions that are used in the battery 1. That is, the non-aqueous electrolyte having the above composition serves as the basis to select the VDF-HFP copolymer when designing the negative electrode 4.

The number average molecular weight of the VDF-HFP copolymer is preferably 100 thousand to 700 thousand. The VDF-HFP copolymer having the number average molecular weight as above, exhibits excellent lithium ion conductivity by contact with the non-aqueous electrolyte, and has good compatibility with the first resin component, in an organic solvent. Also, it is possible to more effectively prevent deterioration in durability, followability, adhesion, etc. of the resin layer 24, which are mainly maintained by the first resin component. By not making the number average molecular weight too small, it is possible to more effectively suppress deterioration in durability of the resin layer 24. By not making the number average molecular weight too large, it is possible to more sufficiently secure lithium ion conductivity of the resin layer 24, and to more effectively suppress deterioration in the compatibility thereof with the first resin component.

Although not limited thereto, in the resin layer 24, the content of the first resin component and the content of the second resin component are preferably 50 mass % to 99 mass % and 1 mass % to 50 mass %, respectively, and further preferably 56 mass % to 76 mass % and 24 mass % to 44 mass %, respectively. This enables obtaining of the resin layer 24 which has durability, followability, and adhesion, each of a high level, as well as good lithium ion conductivity. As a result, there is further improvement in cycle characteristics of the battery 1.

By not making the content of the first resin component too small, or not making the content of the second resin component too large, it is possible to more effectively suppress deterioration in mechanical strength and elasticity of the resin layer 24, and to therefore more effectively increase durability, followability, and adhesion thereof. Also, by not making the content of the first resin component too large, or not making the content of the second resin component too small, lithium ion conductivity of the resin layer 24 is more sufficiently secured, and thus, load characteristics and output characteristics of the battery 1 can be more effectively maintained.

It is preferable to select the respective contents of the first resin component and the second resin component from the aforementioned ranges, and to make the ratio between the first resin component content and the second resin component content (first resin component:second resin component, mass-to-mass ratio) 1:0.2 to 1:1. This enables further improvement in cycle characteristics of the battery 1, without causing deterioration in load characteristics, output characteristics, etc. thereof.

The resin layer 24 is formed as a continuous or discontinuous film on the surface of the granular body 23. A continuous film is a film which partially or entirely covers the granular body 23 surface, and does not have any lacking parts therein (e.g., breaks) which expose the granular body 23 surface. A discontinuous film is a film which partially or entirely covers the granular body 23 surface, and has therein, at least one lacking part. The coverage of the resin layer 24 on the surface of the granular body 23 varies per the granular body 23, but is preferably 30% to 100% and further preferably 50% to 100%. Herein, the coverage is that before the battery is assembled. The coverage is the percentage of the area of the granular body 23 surface where covered with the resin layer 24, relative to the total area of the granular body 23 surface. The coverage can be obtained by observing the surface of the granular body 23 with a scanning electron microscope, a transmission electron microscope, a laser microscope, or the like.

Additionally, by the coverage of the resin layer 24 becoming 50% to 100% after the battery 1 is assembled and fully charged, lithium ion conductivity therein is maintained at a more favorable level, and there is more effective suppression of the side reaction between the newly-generated faces immediately after their generation inside the granular body 23, and the non-aqueous electrolyte. As a result, improvement in cycle characteristics, and suppression of deterioration in load characteristics and output characteristics, occur in a balanced manner. By not making the coverage before the battery assembling too small, there is more effective suppression of the side reaction between the newly-generated faces immediately after their generation inside the granular body 23, and the non-aqueous electrolyte, thereby enabling more effective suppression of deterioration in cycle characteristics of the battery 1.

The thickness of the resin layer 24 is preferably 0.1 μm to 5 μm, and further preferably 0.1 μm to 3 μm. The resin layer 24 with thickness such as above have: durability, followability, and adhesion; and lithium ion conductivity, in a balanced manner. By not making the thickness of the resin layer 24 too small, there is more effective suppression of deterioration in durability, followability, and adhesion of the resin layer 24. By not making the thickness of the resin layer 24 too large, lithium ion conductivity of the resin layer 24 can be more effectively secured.

The resin layer 24 can be formed, for example, by: applying on the surface of the negative electrode active material layer 22, a resin solution containing the first resin component, the second resin component, and an organic solvent; and then drying the resultant coating. The resin solution can be prepared, for example, by dissolving the first resin component and the second resin component in the organic solvent. Examples of the organic solvent include: dimethylformamide, dimethylacetamide, methylformamide, N-methyl-2-pyrrolidone, dimethylamine, acetone, and cyclohexanone.

The content of the resin component (total of the first resin component and the second resin component) in the resin solution can be selected in accordance with: the ratio between the first resin component content and the second resin component content; the thickness of the resin layer 24 to be obtained; or the like, but is preferably 0.1 mass % to 25 mass % and further preferably 1 mass % to 10 mass %, of the total of the resin solution. If the content of the resin component is within the above range, it would be possible to form the resin layer 24 having an overall uniform composition. Also, the resin layer 24 would have better adhesion to the surface of the granular body 23.

The resin solution may also further contain a lithium salt. The lithium salt may be any lithium salt for non-aqueous electrolytes, examples thereof including LiPF₆, LiClO₄, LiBF₄, LiAlCl₄, LiSbF₆, LiSCN, LiAsF₆, LiB₁₀Cl₁₀, LiCl, LiBr, LiI, LiCO₂CF₃, LiSO₃CF₃, and Li(SO₃CF₃).

Application of the resin solution to the surface of the negative electrode active material layer 22 can be performed by any known method for applying liquid substances, and examples thereof include screen printing, die coating, comma coating, roller coating, bar coating, gravure coating, curtain coating, spray coating, air knife coating, reverse coating, dip and squeeze coating, and dip coating. Among these application methods, dip coating is preferred.

The thickness and coverage of the resin layer 24 can be adjusted, for example, by selecting the viscosity, amount for application, time for application (e.g., time for immersion during dip coating), etc., of the resin solution. The viscosity of the resin solution can be adjusted by selecting the resin component concentration in the resin solution, the temperature of the resin solution, etc. The drying temperature for the coating made of the resin solution is selected from the range of, for example, 20° C. to 300° C., depending on the kinds of the resin components contained in the resin solution, the kind of the organic solvent contained in the resin solution, or the like. By drying the coating, the resin layer 24 is formed on the respective surfaces of the granular bodies 23.

The negative electrode current collector 20 is metal foil made of a metallic material, examples of which include copper, copper alloys, stainless steel, and nickel; and has the plurality of the protrusions 21 on both of the surfaces 20a thereof. The protrusion 21 is a protruding matter which extends outward from the surface 20a of the negative electrode current collector 20. The protrusions 21 are separated from one another, and there is a gap of a predetermined size between the adjacent protrusions 21, forming a pair, such pairs being selected arbitrarily from among the protrusions 21. The thickness of the negative electrode current collector 20 where the protrusions 21 are not formed, is preferably 5 μm to 30 μm. Note that the negative electrode current collector 20 in the present embodiment has the protrusions 21 on both of the surfaces thereof, but may have the protrusions 21 on only one of the surfaces thereof. Also, in the present embodiment, the negative electrode current collector 20 is in strip form.

In a vertical section of the negative electrode 4, the height of the protrusion 21 is the length of a perpendicular line extending from the uppermost point of the protrusion 21, downward to the surface 20a. The height of the protrusion 21 is preferably 3 μm to 15 μm. The height of the protrusion 21 can be obtained by: observing a vertical section of the negative electrode 4 with a scanning electron microscope; measuring the respective heights of, for example, 100 protrusions among the protrusions 21; and then averaging out the values obtained from the measurements.

In a vertical section of the negative electrode 4, the width of the protrusion 21 is the maximum length of the protrusion 21 in a direction parallel to the surface 20a. The width of the protrusion 21 is preferably 5 μm to 40 μm. The width of the protrusion 21 can be obtained by: observing a vertical section of the negative electrode 4 with a scanning electron microscope; measuring the respective widths of, for example, 100 protrusions among the protrusions 21; and then averaging out the values obtained from the measurements.

It is not necessary to make all of the protrusions 21 the same in height or width.

In an orthographic drawing of the negative electrode current collector 20 seen perpendicularly from above, the shape of the protrusion 21 is, for example, a polygon ranging from a triangle to an octagon, a circle, an ellipse, or the like. A rhombus, a parallelogram, and a trapezoid are also considered as a polygon.

On the surface 20a of the negative electrode current collector 20, the protrusions 21 are arranged, for example, in a staggered arrangement, a lattice arrangement, or the like. The protrusions 21 may also be arranged irregularly. The granular bodies are preferably aligned closely to one another, to the extent that a gap is secured between the granular bodies adjacent to each other, the gap being capable of reducing stress caused when the granular bodies expand due to charge.

The number of the protrusions 21 is preferably 10 thousand/cm² to 10 million/cm². Also, the axis-to-axis distance between the adjacent protrusions 21 is preferably 10 μm to 100 μm. In instances where the shape of the protrusion 21 is a polygon, the axis thereof passes through the point where the diagonal lines of the polygon intersect, and extends in a direction perpendicular to the surface 20a. In instances where the shape of the protrusion 21 is an ellipse, the axis thereof passes through the point where the major and minor axes of the ellipse intersect, and extends in a direction perpendicular to the surface 20a. In instances where the shape of the protrusion 21 is a circle, the axis thereof passes through the center of the circle, and extends in a direction perpendicular to the surface 20a.

The negative electrode current collector 20 is produced, for example, by: creating a nipped part between two rollers which are intended for creating protrusions and thus have a plurality of depressions on their respective surfaces, by applying pressure to the rollers so that they come into close contact with each other and their respective axes become parallel to each other; and then passing metal foil through this nipped part for it to be pressure molded. This causes formation, on both surfaces of the metal foil and at positions corresponding to those of the depressions on the surfaces of the rollers intended for creating protrusions, the protrusions 21 each having: a shape and size nearly corresponding to the shape and size of the inner space of each of the depressions; and a flat top nearly parallel to the surface 20a. By the above, a negative electrode current collector 20 is obtained. The rollers intended for creating protrusions, used herein, can each be produced by forming depressions by laser beam machining, on a surface of a roller which at least has a surface made of forged steel.

The negative electrode active material layer 22 comprises the granular bodies 23 supported on the respective surfaces of the protrusions 21 on the negative electrode current collector 20. The granular body 23 including an alloy-formable active material extends from the protrusion 21 surface, outward from the negative electrode current collector 20. The granular body 23 may be constituted of a plurality of clusters including an alloy-formable active material. The clusters may be out of alignment with one another. In the present embodiment, the one granular body 23 is formed on the one protrusion 21. At discharge, there is a void 25 between the two granular bodies 23 adjacent to each other. That is, the granular bodies 23 are separated from one another, and there is a void 25 between the respective pairs of the adjacent granular bodies 23 which are arbitrarily selected from the granular bodies 23.

This void 25 reduces stress caused with change in volume of the alloy-formable active material. This results in suppression of the granular body 23 separating from the protrusion 21, of the negative electrode current collector 20 and the negative electrode 4 deforming, etc. Therefore, use of the negative electrode 4 having the above structure enables significant suppression of deterioration in cycle characteristics which is caused due to expansion and contraction of the alloy-formable active material. Also, formation of the resin layer 24 on the granular body 23 surface enables further improvement in cycle characteristics.

The alloy-formable active material constituting the granular body 23 is a material capable of: absorbing lithium by alloying with lithium; and of absorbing and releasing lithium ions in a reversible manner under a negative electrode potential. The alloy-formable active material is preferably in an amorphous or a low crystalline state. The alloy-formable active material may be any known alloy-formable active material, particularly preferred being silicon-based active materials and tin-based active materials. These alloy-formable active materials can be used singly or in a combination of two or more.

Silicon, silicon compounds, silicon alloys, etc. can be given as the silicon-based active materials, although not limited thereto. Specific examples of the silicon compound include a silicon oxide represented by the formula: SiOₐ (0.05<a<1.95), a silicon carbide represented by the formula: SiC_{b} (0<b<1), and a silicon nitride represented by the formula: SiN_{c} (0<c<4/3). A part of the silicon atoms included in the silicon and in the silicon compound may be replaced with atoms of a different element (I). Specific examples of the different element (I) include B, Mg, Ni, Ti, Mo, Co, Ca, Cr, Cu, Fe, Mn, Nb, Ta, V, W, Zn, C, N, and Sn. An example of the silicon alloy is an alloy formed between silicon and a different element (J). Examples of the different element (J) include Fe, Co, Sb, Bi, Pb, Ni, Cu, Zn, Ge, In, Sn, and Ti. Among these silicon-based active materials, the silicon and the silicon oxides are preferred.

Tin, tin compounds, tin alloys, etc. can be given as the tin-based active materials, although not limited thereto. Specific examples of the tin compound include a tin oxide represented by the formula SnOₐ (0<d<2), tin dioxide (SnO₂), SnSiO₃, and tin nitride. An example of the tin alloy is an alloy formed between tin and a different element (K). The different element (K) is at least one selected from the group consisting of Ni, Mg, Fe, Cu and Ti. Specific examples of the above alloy include Ni₂Sn₄ and Mg₂Sn.

The granular bodies 23 can be formed on the respective surfaces of the protrusions 21, simultaneously, by a gas phase method. Examples of a gas phase method include vacuum deposition, sputtering, ion plating, laser ablation, chemical vapor deposition, plasma-enhanced chemical vapor deposition, and thermal spraying. Among the above, vapor deposition is preferred.

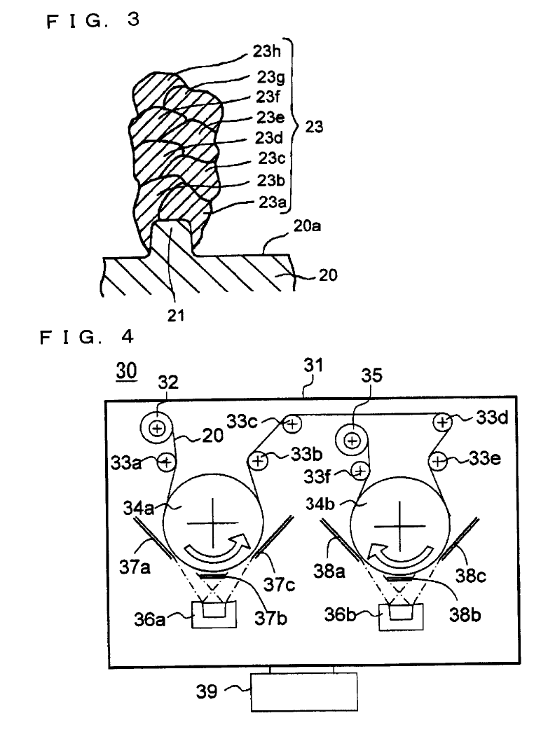

FIG. 3 is a vertical sectional view schematically showing the structure of the granular body 23. The granular body 23 is formed, by vacuum deposition, as a stack of lumps 23a to 23h as shown in FIG. 3. Note that the number of lumps that are stacked is not limited to eight, and an arbitrary number of lumps, being two or more, can be stacked.

In forming the granular body 23, which is a stack of the lumps 23a to 23h, first, the lump 23a is formed so that it is supported on the surface of the protrusion 21. Next, the lump 23b is formed so that it is supported on the remaining surface of the protrusion 21 and the surface of the lump 23a. The lump 23c is formed so that it is supported on the remaining surface of the lump 23a and the surface of the lump 23b. Further, the lump 23d is formed so that it is supported on the remaining surface of the lump 23b and the surface of the lump 23c. In the same manner as above, the lumps 23e, 23f, 23g, and 23h are stacked alternately, thereby obtaining a granular body 23. Examples of the three-dimensional form taken by the granular body 23 include a pillar, a spindle, and a rough sphere. A column and a prism are considered to be of a pillar form.

In a vertical section of the negative electrode 4, the height of the granular body 23 is the length of a perpendicular line extending from the uppermost point of the granular body 23, downward to the flat upper surface of the protrusion 21. The height of the granular body 23 is preferably 5 μm to 30 μm. In a cross section of the negative electrode 4, the width of the granular body 23 is the maximum length thereof in a direction parallel to the surface 20a. The width of the granular body 23 is preferably 5 μm to 50 μm. The height and width of the granular body 23 can be obtained in a manner similar to obtaining those of the protrusion 21, that is, by observing vertical and cross sections of the negative electrode 4 with a scanning electron microscope.

The positive electrode 3 comprises the positive electrode current collector, and a positive electrode active material layer formed on both surfaces of the positive electrode current collector. In the present embodiment, the positive electrode active material layer is formed on both surfaces of the positive electrode current collector, but it may also be formed on one surface thereof.

The positive electrode current collector may be metal foil or the like, made of a metallic material, examples of which include aluminum, aluminum alloys, stainless steel, and titanium. Among the above metallic materials, aluminum and aluminum alloys are preferred. The thickness of the positive electrode current collector is preferably 10 μm to 30 μm, although not particularly limited thereto. The positive electrode current collector in the present embodiment is in strip form.

The positive electrode active material layer includes a positive electrode active material, a binder, and a conductive agent. The positive electrode active material layer can be formed, for example, by applying a positive electrode material mixture slurry on the surface(s) of the positive electrode current collector, and then drying and rolling the resultant coating. The positive electrode material mixture slurry can be prepared, for example, by mixing the positive electrode active material, the binder, and the conductive agent, together with a dispersion medium.

The positive electrode active material may be any known positive electrode active material, particularly preferred being a lithium-containing composite oxide and an olivine-type lithium salt.

The lithium-containing composite oxide is a metal oxide comprising lithium and a transition metal element, or a metal oxide comprising the same except that part of the transition metal element is replaced with a different element. Examples of the transition metal element include Sc, Y, Mn, Fe, Co, Ni, Cu, and Cr. Among these transition metal elements, Mn, Co, Ni, etc. are preferred. These transition metal elements can be used singly or in a combination of two or more. Examples of the different element include Na, Mg, Zn, Al, Pb, Sb, and B. Among these different elements, Mg, Al, etc. are preferred. These different elements can be used singly or in a combination of two or more.

Specific examples of the lithium-containing composite oxide include LiₓCoO₂, LiₓNiO₂, LiₓMnO₂, LiₓCoₘNi₁₋ₘO₂, LiₓCoₘM₁₋ₘOₙ, LiₓNi₁₋ₘMₘOₙ, LiₓMn₂O₄, and LiₓMn₂₋ₘMₘO₄, where, in all these formulae: M indicates at least one element selected from the group consisting of Na, Mg, Sc, Y, Mn, Fe, Co, Ni, Cu, Zn, Al, Cr, Pb, Sb, and B; 0<x≦1.2; 0≦m≦0.9; and 2.0 n 2.3. Among these, LiₓCoₘM₁₋ₘOₙ, is preferred.

Specific examples of the olivine-type lithium salt include LiZPO₄ and Li₂ZPO₄F, where, in both formulae: Z indicates one element selected from the group consisting of Co, Ni, Mn, and Fe.

In all of the above formulae respectively representing the lithium-containing composite oxides and the olivine-type lithium salts, the number of moles of lithium is the value immediately after their synthesis, and increases and decreases by charge and discharge. These positive electrode active materials can be used singly or in a combination of two or more.

Examples of the binder include: resin materials such as polytetrafluoroethylene and polyvinylidene fluoride; and rubber materials such as styrene butadiene rubber containing acrylic acid monomers (trade name: BM-500B, available from ZEON Corporation) and styrene butadiene rubber (trade name: BM-400B, available from ZEON Corporation). Examples of the conductive agent include: carbon blacks such as acetylene black and ketjen black; and graphites such as natural graphite and artificial graphite. The respective contents of the binder and the conductive agent can be changed as appropriate in accordance with, for example, the design of the positive electrode 3, the design of the battery 1, or the like.

The dispersion medium which is mixed with the positive electrode active material, the binder, and the conductive agent, may be, for example: an organic solvent such as N-methyl-2-pyrrolidone, tetrahydrofuran, dimethylformamide, or the like; water; or the like.

The separator 5 interposed between the positive electrode 3 and the negative electrode 4 may be: a porous sheet having pores; a non-woven fabric made of resin fiber; a fabric made of resin fiber; or the like. Among these, the porous sheet is preferred, further preferred being such having a pore size of about 0.05 μm to 0.15 μm. The thicknesses of the porous sheet, the non-woven fabric, and the woven fabric are preferably 5 μm to 30 μm. Examples of the resin material constituting the porous sheet and the resin fiber, include: polyolefins such as polyethylene and polypropylene; polyamides; and polyamide imides. The separator 5 in the present embodiment is in strip form.

The non-aqueous electrolyte contains a lithium salt and a non-aqueous solvent. Examples of the lithium salt include LiPF₆, LiClO₄, LiBF₄, LiAlCl₄, LiSbF₆, LiSCN, LiAsF₆, LiB₁₀Cl₁₀, LiCl, LiBr, LiI, LiCO₂CF₃, LiSO₃CF₃, Li (SO₃CF₃)₂. LiN(SO₂CF₃)₂, and lithium imide salt. These lithium salts can be used singly or in a combination of two or more. The concentration of the lithium salt in 1 L of the non-aqueous solvent is preferably 0.2 to 2 moles and further preferably 0.5 to 1.5 moles.

Examples of the non-aqueous solvent include: cyclic carbonic acid esters such as ethylene carbonate, propylene carbonate, and butylene carbonate; chain carbonic acid esters such as dimethyl carbonate, ethyl methyl carbonate, and diethyl carbonate; chain ethers such as 1,2-dimethoxyethane and 1,2-diethoxyethane; cyclic carboxylic acid ester such as γ-butyrolactone and γ-valerolactone; and chain esters such as methyl acetate. These non-aqueous solvents can be used singly or in a combination of two or more.

The lithium ion secondary battery of the aforementioned embodiment is a cylindrical battery comprising a wound electrode assembly, but is not limited thereto. The lithium ion secondary battery of the present invention can be in various forms, and examples thereof include: a cylindrical battery in which a battery case housing a wound electrode assembly, a non-aqueous electrolyte, etc. is sealed with a sealing plate which supports a positive terminal and is made of an insulating material; a prismatic battery in which a wound electrode assembly, a flat electrode assembly, or a stacked electrode assembly is housed in a prismatic battery case; a laminate film battery in which a wound electrode assembly, a flat electrode assembly, or a stacked electrode assembly is housed in a battery case made of laminate film; and a coin battery in which a stacked electrode assembly is housed in a coin battery case.

### EXAMPLES

Hereinafter, the present invention will be described more specifically with reference to Examples and Comparative Examples.

### Example 1

### (a) Production of Positive Electrode

Eighty-five parts by mass of a positive electrode active material (LiNi_{0.080}Co_{0.15}Al_{0.05}O₂), 10 parts by mass of graphite powder, and 5 parts by mass of polyvinylidene fluoride powder were mixed together with a proper amount of N-methyl-2-pyrrolidone, thereby preparing a positive electrode material mixture slurry. The positive electrode material mixture slurry thus obtained was applied to both surfaces of aluminum foil (positive electrode current collector) having a thickness of 15 μm, and the coatings thus obtained were dried and rolled, thereby producing a positive electrode having a thickness of 130 μm. The positive electrode thus obtained was cut to have a width capable of being inserted into a battery case for a 14400-type cylindrical battery (diameter: about 14 mm, height: about 40 mm).

### (b) Production of Negative Electrode

(b-1) Production of Negative Electrode Current Collector

Two rollers were brought into close contact with each other by applying pressure thereto so that their respective axes became parallel to each other, thereby creating a nipped part. These two rollers were made of forged steel, and had on their respective surfaces, a plurality of depressions arranged in a staggered manner, each of the depressions having a rhombus-shaped opening. Electrolytic copper foil (available from Furukawa Circuit Foil Co., Ltd.) having a thickness of 35 μm was passed through the nipped part at a linear pressure of 1000 N/cm, thereby producing a negative electrode current collector 20 having a plurality of protrusions 21 on both surfaces thereof.

The protrusions 21 had an average height of 8 μm and were arranged in a staggered manner. Also, the top of the protrusion 21 was a flat surface, nearly parallel to the surfaces 20a of the negative electrode current collector 20. Also, in an orthographic drawing of the negative electrode current collector 20 seen perpendicularly from above, the shape of the protrusions 21 was nearly a rhombus. Also, the axis-to-axis distance between the protrusions 21 was 20 μm in the length direction of the negative electrode current collector 20 and 40 μm in the width direction thereof.

(b-2) Formation of Negative Electrode Active Material Layer

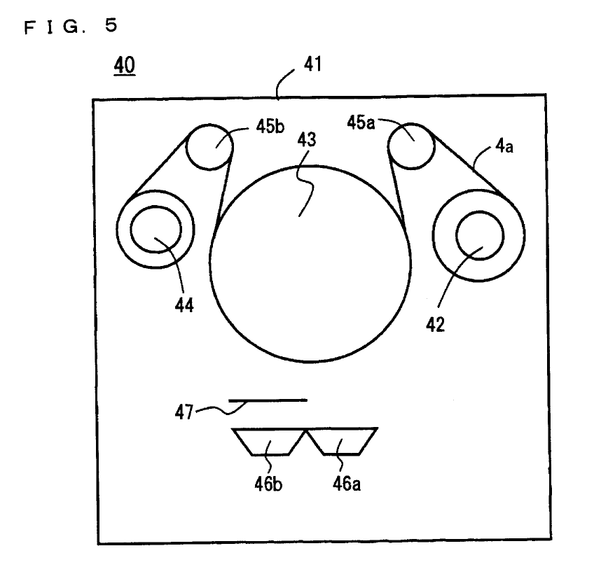

FIG. 4 is a front view schematically showing the inside configuration of an electron-beam vacuum deposition device 30 (available from ULVAC, Inc., hereafter referred to as “deposition device 30”). In FIG. 4, the components disposed inside the deposition device 30 are indicated by solid lines. With use of the deposition device 30, granular bodies 23 were formed on the respective surfaces of the protrusions 21 (not shown in FIG. 4) on the negative electrode current collector 20 obtained above, thereby producing a negative electrode precursor.

With respect to the deposition device 30, disposed outside of a chamber 31 being a pressure-resistant container, was a vacuum pump 39 for reducing pressure in the chamber 31. Also, the following components were housed inside the chamber 31. The negative electrode current collector 20 in strip form was rolled into a feeding roller 32. Carrying rollers 33a, 33b, 33c, 33d, 33e, and 33f carried the negative electrode current collector 20 fed from the feeding roller 32. Film forming rollers 34a and 34b each had therein a cooling device (not shown), and enabled an alloy-formable active material to be deposited on the surfaces of the negative electrode current collector 20 where running on the roller surfaces. A take-up roller 35 took up the negative electrode current collector 20 which was carried thereto.

Vapor deposition sources 36a and 36b each contained a source for the alloy-formable active material. The vapor deposition sources 36a and 36b were irradiated with an electron beam from an electron beam generating device (not shown), thereby generating vapor of the alloy-formable active material source. Shield plates 37 and 38 regulated the area where the vapor of the alloy-formable active material source was supplied on the surfaces of the negative electrode current collector 20. The shield plate 37 had shield strips 37a, 37b, and 37c. The shield plate 38 had shield strips 38a, 38b, and 38c. In the carrying direction of the negative electrode current collector 20, a first vapor deposition region was formed between the shield strips 37a and 37b; a second vapor deposition region was formed between the shield strips 37b and 37c; a third vapor deposition region was formed between the shield strips 38c and 38b; and the fourth vapor deposition region was formed between the shield strips 38b and 38a. Oxygen nozzles (not shown) were respectively disposed near each of the vapor deposition regions, and oxygen was supplied therefrom.

Scrap silicon (single silicon crystal, purity of 99.9999%, available from Shin-Etsu Chemical Co., Ltd.) was used for the alloy-formable active material source, and this was put in the vapor deposition sources 36a and 36b. After air was exhausted from inside the chamber 31 with use of the vacuum pump 39 until reaching 5×10⁻³ Pa, oxygen was supplied to inside the chamber 31 from the oxygen nozzles, thereby creating an oxygen atmosphere with a pressure of 3.5 Pa. Next, the scrap silicon contained in the vapor deposition sources 36a and 36b was irradiated with an electron beam (acceleration voltage: 10 kV, emission: 500 mA), thereby generating silicon vapor. The silicon vapor, during its ascension, was mixed with oxygen, thereby producing a gaseous mixture of the silicon vapor and the oxygen.

Meanwhile, the negative electrode current collector 20 was fed from the feeding roller 32 at a speed of 2 cm/min, and the mixture of the silicon vapor and the oxygen was vapor-deposited on the surface of the protrusion 21 on the negative electrode current collector 20 where running through the first vapor deposition region, thereby forming a lump 23a shown in FIG. 3. Next, a lump 23b was formed, on the surface of the protrusion 21 and the surface of the lump 23a thereon, on the negative electrode current collector 20 where running through the second vapor deposition region. Further, at the third and fourth vapor deposition regions, the lumps 23a and 23b were stacked on the surface of the protrusion 21 on the opposite surface of that where the lumps 23a and 23b had been formed at the first and second vapor deposition regions.

Next, the rolling directions of the feeding roller 32 and the take-up roller 35 were reversed, thereby reversing the feeding direction of the negative electrode current collector 20, and thus, lumps 23c and 23d were stacked on the surfaces of the lumps 23a and 23b on the both surfaces, respectively, of the negative electrode current collector 20. Thereafter, one round of vapor deposition was performed in a similar manner, and granular bodies 23, each being a stack of the lumps 23a, 23b, 23c, and 23d, and lumps 23e, 23f, 23g, and 23h, were formed on the respective surfaces of the protrusions 21 on the both surfaces of the negative electrode current collector 20, thereby producing a negative electrode precursor. In FIG. 5, this negative electrode precursor is indicated as 4a.

The granular body 23 was supported on the surface of the protrusion 21, and grew in a manner such that it extended outward from the negative electrode current collector 20. The granular body 23 had a three-dimensional form which was roughly columnar. The granular body 23 had an average height of 15 μm and an average width of 15 μm. Also, quantification of the amount of oxygen contained in the granular body 23 was performed by a combustion method, and it was found that the composition of the granular body 23 was SiO_{0.5}.

FIG. 5 is a front view schematically showing the inside configuration of another kind of a vacuum deposition device 40 (hereafter referred to as “deposition device 40”). In FIG. 5, the components disposed inside the deposition device 40 are indicated by solid lines. With use of the deposition device 40, lithium of an amount equivalent to irreversible capacity was supplemented respectively to negative electrode active material layers 22 comprising the plurality of the granular bodies 23 and being on both surfaces of the negative electrode precursor 4a obtained above. The deposition device 40 has a chamber 41 which is a pressure-resistant container, and the following components are disposed inside the chamber 41.

The negative electrode precursor 4a in strip form was rolled into a feeding roller 42. A can 43 had therein a cooling device (not shown), and enabled lithium to be deposited on the surface of the negative electrode precursor 4a where running on the can surface. A take-up roller 44 took up the negative electrode precursor 4a. Carrying rollers 45a and 45b carried the negative electrode precursor 4a fed from the feeding roller 42, toward the take-up roller 44, via the can 43. Vapor deposition sources 46a and 46b made of tantalum contained lithium metal. By heating the vapor deposition sources 46a and 46b, lithium vapor was generated. A shield plate 47 regulated the supply of the lithium vapor to the surface of the negative electrode precursor 4a.

The atmosphere inside the chamber 41 was replaced with an argon atmosphere, and the degree of vacuum therein was made to be 1×10⁻¹ Pa with use of a vacuum pump (not shown). Next, current was carried to the vapor deposition sources 46a and 46b from a power source (not shown), thereby generating lithium vapor; and also, the negative electrode precursor 4a was fed from the feeding roller 42 at a speed of 2 cm/min, and at the moment when the negative electrode precursor 4a passed the surface of the can 43, lithium of an amount equivalent to irreversible capacity was vapor-deposited on surfaces of the negative electrode active material layers 22 formed on the negative electrode precursor 4a. Vapor deposition of lithium was performed on both of the negative electrode active material layers 22 formed on the negative electrode precursor 4a. The negative electrode precursor 4a after lithium vapor deposition was cut to have a width capable of being inserted into a battery case for a 14400-type cylindrical battery (diameter: about 14 mm, height: about 40 mm).

### (c) Formation of Resin Layer

A VDF-HFP copolymer (1) (HFP content: 0.1 mol %, degree of swelling: 15%, number average molecular weight: four hundred thousand) and a polyimide (number average molecular weight: one hundred thousand) were dissolved in N-methyl-2-pyrrolidone, thereby preparing a resin solution containing: the VDF-HFP copolymer in a proportion of 33 mass % of the total solid content; and the polyimide in a proportion of 67 mass % of the total solid content. After heating this resin solution to 120° C., the negative electrode precursor obtained above was immersed therein for one minute and then taken out. The negative electrode precursor after immersion was vacuum-dried at 85° C. for ten minutes, thereby forming on the surface of the granular body, a resin layer including 33 mass % of the VDF-HFP copolymer and 67 mass % of the polyimide.

The negative electrode obtained above was observed with a scanning electron microscope. The resin layer was formed on the respective surfaces of the granular bodies. Ten of the granular bodies were selected, the thicknesses of the resin layers formed on the surfaces of these granular bodies were measured, and it was found that each of these thicknesses fell within the range of 0.1 μm to 5 μm. Also, for each of these granular bodies, the thickness of the resin layer was measured at three arbitrary points, and as a result of averaging out the values obtained from the measurements at a total of 30 points, the average thickness of the resin layer was found to be 0.6 μm.

Further, for each of these granular bodies, the total surface area and the surface area covered with the resin layer were measured, and it was found that the coverage of the resin layer fell within the range of 30% to 100%. Also, the average coverage of the resin layer for the ten granular bodies was obtained, resulting in being 95%.

### (d) Preparation of Non-Aqueous Electrolyte

LiPF₆ was dissolved at a concentration of 1.0 mol/L in a mixed solvent of ethylene carbonate and ethyl methyl carbonate at a volume-to-volume ratio of 1:1, thereby preparing a non-aqueous electrolyte.

### (e) Assembling of Battery

The positive and negative electrodes obtained above were wound with a separator (trade name: Hipore, porous polyethylene membrane, available from Asahi Kasei Corporation) having a thickness of 20 μm interposed therebetween, thereby producing a wound electrode assembly. One end of an aluminum lead was connected to the positive electrode current collector, and one end of a nickel lead was connected to the negative electrode current collector. An upper insulating plate and a lower insulating plate, both made of polypropylene, were attached to the longitudinal ends, respectively, of the wound electrode assembly. Next, this wound electrode assembly was housed in a bottomed, cylindrical, iron-made battery case; and also, the other end of the aluminum lead was connected to a sealing plate made of stainless steel, and the other end of the nickel lead was connected to the inner surface of the battery case bottom.

Next, the non-aqueous electrolyte was injected into the battery case by depressurization. A gasket made of polypropylene was attached to the periphery of the sealing plate supporting a safety value, and in this state, the sealing plate was attached to the opening of the battery case. The edge of the battery case opening was crimped onto the sealing plate, thereby sealing the battery case in an airtight manner. As such, three 14400-type cylindrical lithium ion secondary batteries, each being 14 mm in outer diameter and 40 mm in height, were produced.

### Example 2

Except for using polyacrylic acid (number average molecular weight: two thousand) in place of the polyimide in “(c) Formation of resin layer”, three cylindrical lithium ion secondary batteries were produced in the same manner as Example 1.

### Example 3

Except for using a VDF-HFP copolymer (2) (HFP content: 8 mol %; degree of swelling: 160%; number average molecular weight: five thousand) in place of the VDF-HFP copolymer (1) in “(c) Formation of resin layer”, three cylindrical lithium ion secondary batteries were produced in the same manner as Example 1.

### Example 4

Except for, in “(c) Formation of resin layer”, changing the respective proportions of the VDF-HFP copolymer (1) and the polyimide to be used and thus forming a resin layer including 60 mass % of the VDF-HFP copolymer (1) and 40 mass % of the polyimide, three cylindrical lithium ion secondary batteries were produced in the same manner as Example 1.

### Comparative Example 1

Except for not forming the resin layer, three cylindrical lithium ion secondary batteries were produced in the same manner as Example 1.

### Comparative Example 2

Except for using only the VDF-HFP copolymer (1) instead of using the VDF-HFP copolymer (1) together with the polyimide in “(c) Formation of resin layer”, three cylindrical lithium ion secondary batteries were produced in the same manner as Example 1.

### Comparative Example 3

Except for using only the polyimide instead of using the polyimide together with the VDF-HFP copolymer (1) in “(c) Formation of resin layer”, three cylindrical lithium ion secondary batteries were produced in the same manner as Example 1.

### [Battery Capacity]

The batteries of Examples 1 to 4 and Comparative Examples 1 to 3 were each housed in a constant temperature chamber of 25° C., and subjected to three cycles of charge and discharge, each cycle consisting of charge (constant current charge, followed by constant voltage charge) and discharge (constant current discharge) under the following charge/discharge conditions; and the discharge capacity (capacity at 0.2 C) at the third cycle was obtained and designated as battery capacity.

Constant-Current charge: 0.3 C charge current, 4.15 V end-of-charge voltage

Constant-Voltage charge: 4.15 V charge voltage, 0.05 C end-of-charge current, 20 min rest time

Constant-Current discharge: 0.2 C discharge current, 2.5 V end-of-discharge voltage, 20 min rest time

### [Cycle Characteristics]

The batteries of Examples 1 to 4 and Comparative Examples 1 to 3 were each housed in a constant temperature chamber of 25° C., and subjected to one cycle of charge and discharge under the same conditions as those for evaluating the battery capacity, so as to obtain the discharge capacity at the first cycle. Thereafter, except for changing the current for the Constant-Current discharge from 0.2 C to 1 C, two to 199 cycles of charge and discharge were performed under the same conditions as those for the first cycle. Next, one cycle of charge and discharge was performed under the same conditions as those for the first cycle, and the discharge capacity at 0.2 C at 200 cycles was obtained. Further, one cycle of charge and discharge was performed under the same conditions as those for the second cycle, and the discharge capacity at 1 C at 201 cycles was obtained.

Capacity retention rate A (%) was obtained as the percentage of the discharge capacity at 0.2 C at 200 cycles, relative to the discharge capacity at the first cycle. The capacity retention rate A was the capacity retention rate during discharge at 0.2 C at 200 cycles. Also, capacity retention rate B (%) was obtained as the percentage of the discharge capacity at 1 C at 201 cycles, relative to the discharge capacity at the first cycle. The capacity retention rate B was the capacity retention rate during discharge at 1 C at 201 cycles. Further, capacity retention rate C was obtained as the percentage of the capacity retention rate B relative to the capacity retention rate A. The results are shown in Table 1.

TABLE 1

| | capacity retention | capacity retention | capacity retention |
|---|---|---|---|
| | rate A | rate B | rate C |
| | (0.2 C) (%) | (1 C) (%) | (1 C/0.2 C) (%) |
| Ex. 1 | 85 | 71 | 83 |
| Ex. 2 | 90 | 79 | 88 |
| Ex. 3 | 88 | 74 | 84 |
| Ex. 4 | 82 | 69 | 84 |
| Comp. | 81 | 66 | 81 |
| Ex. 1 | | | |
| Comp. | 83 | 68 | 82 |
| Ex. 2 | | | |
| Comp. | (unable to be | (unable to be | (unable to be |
| Ex. 3 | charged & | charged & | charged & |
| | discharged) | discharged) | discharged) |

It is evident from Table 1, that, in a lithium ion secondary battery having a negative electrode active material layer which is an aggregate of a plurality of granular bodies comprising an alloy-formable active material, covering the surface of the granular body with a resin layer composed of a first resin component and a second resin component enables improved cycle characteristics of the battery, and also enables suppression of rapid deterioration in cycle characteristics thereof even with increase in the number of times of charge and discharge.

Compared to the batteries of Comparative Examples 1 to 2, the batteries of Examples 1 to 3 exhibited further improvements in the capacity retention rate A indicating cycle characteristics at low power, and in capacity retention rate B indicating cycle characteristics at high power. The battery of Example 2 particularly exhibited a more remarkable improvement in the capacity retention rates A and B, compared to the batteries of Comparative Examples 1 to 2. This is presumably due to the resin layers in the batteries of Examples 1 to 3 including the first resin component, being the polyimide or the polyacrylic acid, and the second resin component, being the VDF-HFP copolymer, in appropriate proportions, respectively. This presumably enabled obtaining a resin layer having lithium ion conductivity as well as durability, followability, and adhesion, all of a high level, thereby improving cycle characteristics.

Additionally, in comparing the batteries of Examples 1 and 3 with the battery of Example 2, it was found that cycle characteristics further improved with use of the polyacrylic acid as the first resin component.

On the other hand, the battery of Comparative Example 1, not having the resin layer formed therein, and the battery of Comparative Example 2, having the resin layer composed of only the VDF-HFP copolymer formed therein, both had cycle characteristics to a certain extent, since lithium ion conductivity to the granular bodies was secured therein. However, the battery of Comparative Example 3, having the resin layer composed of only the polyimide, could not be charged or discharged. This is presumably due to the supplying of lithium ions to the granular bodies being suppressed significantly by the resin layer composed of only the polyimide.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The lithium ion secondary battery of the present invention can be used for applications similar to those for which a conventional lithium ion secondary battery is used, and is particularly useful as main power sources or auxiliary power sources for electronic equipment, electrical equipment, machine tools, transport equipment, electrical energy storage equipment, etc. As electronic equipment, there are personal computers, cellular phones, mobile equipment, personal digital assistants, portable game consoles, etc. As electrical equipment, there are vacuum cleaners, video cameras, etc. As machine tools, there are electric tools, robots, etc. As transport equipment, there are electric vehicles, hybrid electric vehicles, plug-in hybrid electric vehicles, fuel cell vehicles, etc. As electrical energy storage equipment, there are uninterruptible power supply, etc.

### EXPLANATION OF REFERENCE NUMERALS

1 lithium ion secondary battery
2 wound electrode assembly
3 positive electrode
4 negative electrode
5 separator
10 positive lead
11 negative lead
12 upper insulating plate
13 lower insulating plate
14 battery case
15 sealing plate
16 gasket
20 negative electrode current collector
21 protrusion
22 negative electrode active material layer
23 granular body
25 gap
30 electron-beam vacuum deposition device
40 vacuum deposition device

1. A negative electrode for lithium ion secondary batteries, comprising: a negative electrode current collector having a plurality of protrusions formed on a surface thereof; and a plurality of granular bodies, the granular bodies being supported on the protrusions, respectively, and including an alloy-formable active material capable of absorbing and releasing lithium ions,
wherein the granular bodies each have a resin layer including: a first resin component which is at least one selected from polyimides and polyacrylic acid; and a second resin component which is composed of a copolymer including vinylidene fluoride units and hexafluoropropylene units.

2. The negative electrode for lithium ion secondary batteries in accordance with claim 1, wherein the thickness of the resin layer is 0.1 μm to 5 μm.

3. The negative electrode for lithium ion secondary batteries in accordance with claim 1, wherein, in the resin layer, the content of the first resin component is 50 mass % to 99 mass % and the content of the second resin component is 1 mass % to 50 mass %.

4. The negative electrode for lithium ion secondary batteries in accordance with claim 3, wherein the ratio between the content of the first resin component and the content of the second resin component is 1:0.2 to 1:1, by mass.

5. The negative electrode for lithium ion secondary batteries in accordance with claim 1, wherein the degree of swelling of the copolymer in a non-aqueous electrolyte, is 15% or more.

6. The negative electrode for lithium ion secondary batteries in accordance with claim 1, wherein the coverage of the resin layer on the surface of the granular body, is 30% to 100%.

7. The negative electrode for lithium ion secondary batteries in accordance with claim 6, wherein, at full charge, the coverage of the resin layer on the surface of the granular body is 50% to 100%.

8. The negative electrode for lithium ion secondary batteries in accordance with claim 1, wherein the alloy-formable active material is at least one selected from silicon-based active materials and tin-based active materials.

9. A lithium ion secondary battery comprising: a positive electrode capable of absorbing and releasing lithium ions; a negative electrode capable of absorbing and releasing lithium ions; a separator interposed between the positive electrode and the negative electrode; and a non-aqueous electrolyte,
wherein the negative electrode is the negative electrode for lithium ion secondary batteries in accordance with claims 1.
